(19) United States
(12) Patent Application Publication
(10) Pub. No.: US 2025/0109064 A1
(43) Pub. Date: Apr. 3, 2025

(54) SILICEOUS MATERIALS AND METHODS OF MANUFACTURE

(71) Applicant: Sublime Systems, Inc., Somerville, MA (US)

(72) Inventors: Yet-Ming CHIANG, Wellesley, MA (US); Jesse D. BENCK, Wakefield, MA (US); Michael C. STERN, Sudbury, MA (US); Joseph HITTINGER, Somerville, MA (US)

(73) Assignee: Sublime Systems, Inc., (US)

(21) Appl. No.: 18/834,414

(22) PCT Filed: Feb. 7, 2023
(86) PCT No.: PCT/US2023/062144

§ 371 Date: Jul. 30, 2024

Related U.S. Application Data
(60) Provisional application No. 63/307,446, filed on Feb. 7, 2022.
(60) Provisional application No. 63/363,650, filed on Apr. 27, 2022.
(60) Provisional application No. 63/436,307, filed on Dec. 30, 2022.

(51) Int. Cl. C04B 7/34; C04B 7/38

(52) U.S. Cl. CPC C04B 7/34; C04B 7/38; C04B 2201/20; C04B 2201/50

(57) ABSTRACT

Provided herein are processed siliceous materials. Also provided herein are methods of processing siliceous materials, and more specifically methods of processing siliceous materials using fluoride-containing and/or hydroxide-containing compounds.

### CROSS-REFERENCE TO RELATED APPLICATIONS

This application claims the benefit of U.S. Provisional Application No. 63/307,446 filed Feb. 7, 2022; U.S. Provisional Application No. 63/363,650 filed Apr. 27, 2022; and U.S. Provisional Application No. 63/436,307, filed Dec. 30, 2022, the entire contents of each of which are incorporated herein by reference.

### FIELD

The present disclosure relates generally to methods of processing siliceous materials, and more specifically to methods of processing siliceous materials using fluoride-containing and/or hydroxide-containing compounds.

### BACKGROUND

Siliceous materials are a common form of supplementary cementitious material (SCM) that can be added to ordinary portland cement (OPC) to form a blended cement product. The blended cement may have significant advantages including increased strength, increased durability, and reduced cost. Siliceous SCMs are often derived from the fly ash generated at coal-fired power plants. Other examples are silica fume generated from electric arc furnaces. However, the availability of such materials is insufficient for the current needs of the cement industry. Further, the quality of fly ashes may vary significantly making their use challenging for cement and concrete mix designers.

### BRIEF SUMMARY

This disclosure relates to processed siliceous materials and methods of processing siliceous material to improve their properties and improve their utility, either alone or as a component of other products.

Siliceous materials may constitute an important component in many materials, including cementitious construction materials such as cements, cement mortars, and concretes. In these applications, the properties of the siliceous materials used, especially their reactivity and flowability, can be critical to the functionality of the resulting products.

For example, in the manufacture of portland cement, the reactivity of lime and silica during high temperature firing can be important to the energy-efficient production of clinker with desired properties. For pozzolanic cements, the reactivity of the pozzolan, which is the primary siliceous phase of matter used, can be critical to the development of properties during the cement hydration reactions. For supplemental cementitious materials (SCM) such as ashes and slags, the reactivity of the SCM in the cementitious mixture can be a key selection criterion. In mortars and in concrete, the reactivity of the non-cement paste materials, such as sand, gravel, and aggregate, can affect the bonding between the cement paste and the aggregate. Many siliceous materials have not found widespread use in cement and concrete due to their insufficient reactivity, despite their low cost and abundance. For example, while fly ash from coal-fired power plants is widely used as an SCM, bottom ash is not, largely due to its limited reactivity. As another example, clays can typically be calcined in order to increase their reactivity for use in cements.

Likewise, the flowability of a siliceous material can also be important because minimizing the amount of added water in the final product can be critical for ensuring high strength and durability. In some embodiments and applications, different siliceous materials may require variable amounts of water to achieve the appropriate flowability.

Accordingly, disclosed herein are methods of processing siliceous materials to increase their reactivity and flowability and the processed siliceous materials themselves. This may be achieved by chemically modifying the morphology of the siliceous materials, more specifically by dissolving, in part or completely, the siliceous materials and precipitating, in part or completely, them in a more reactive and/or flowable form. However, it can be difficult to dissolve siliceous materials, and there are few known methods for doing so. Traditionally, the dissolution of siliceous materials has been accomplished using chemical reagents such as hydrofluoric acid (HF), alkali metal hydroxides (AMHs) (including NaOH and KOH), and high temperature melts (for example, molten chlorides or fluorides or oxides). However, all of these methods have drawbacks. Hydrofluoric acid is highly toxic and unsafe, and high temperature melts require high temperatures and high reactant concentrations. Use of AMHs is typically expensive due to the high cost of regenerating the alkali metals once the silica is precipitated through the addition of an acid precipitating agent such as hydrochloric acid, sulfuric acid, or carbon dioxide.

In contrast, as disclosed herein, certain fluoride-containing compounds including, but not limited to, ammonium fluoride (NH₄F), ammonium bifluoride (NH₄HF₂), acid ammonium fluoride (3NH₄·HF₂), and disodium fluorophosphate (Na₂PO₃F) and/or hydroxide-containing compounds including, but not limited to, sodium hydroxide and potassium hydroxide may be able to dissolve siliceous materials. These compounds can be significantly less toxic than HF, and exhibit greater reactivity at lower temperatures and lower concentrations than the high temperature melts.

In addition to silicon-based oxides, such as silica, siliceous materials often also contain significant quantities of aluminum oxides, hydroxides, or salts that can contribute to the supplementary cementitious properties of the siliceous materials. As disclosed herein, certain novel approaches for AMH can be used to alleviate the traditionally high cost of acid and base regeneration. These approaches can include dissolving primarily the aluminum oxides or hydroxides, which can be precipitated through temperature swing and/or by only partial dissolution of the silica and/or regeneration of the AMH with low energy processes.

In some embodiments, a method for processing siliceous materials includes dissolving a feedstock siliceous material in the presence of a fluoride-containing compound selected from the group consisting of ammonium fluoride, ammonium bifluoride, acid ammonium fluoride, disodium fluorophosphate, or combinations thereof and/or a hydroxide-containing compound selected from the group consisting of sodium hydroxide, potassium hydroxide, or combinations thereof; and precipitating the dissolved feedstock siliceous material to provide a processed siliceous material. In some embodiments, the method comprises using the processed siliceous material to prepare a cementitious material. In some embodiments, the cementitious material is a pozzolanic cement. In some embodiments, the dissolving comprises dissolving between 20 wt. % and 50 wt. % of the feedstock siliceous material. In some embodiments, the dissolving comprises dissolving between 5 wt. % and 20 wt. % of the feedstock siliceous material. In some embodiments, the precipitating comprises precipitating 100% of the dissolved feedstock siliceous material. In some embodiments, the precipitating comprises heterogeneously precipitating the dissolved feedstock siliceous material onto an undissolved portion of the feedstock siliceous material. In some embodiments, the precipitating comprises heterogeneously precipitating the dissolved feedstock siliceous material onto a siliceous material other than the feedstock siliceous material. In some embodiments, the precipitating comprises heterogeneously precipitating the dissolved feedstock siliceous material onto a recycled portion of the product siliceous material. In some embodiments, the precipitating comprises homogeneously precipitating the dissolved feedstock siliceous material. In some embodiments, the feedstock siliceous material is crystalline. In some embodiments, the feedstock siliceous material is amorphous. In some embodiments, the feedstock siliceous material comprises coal ash such as fly ash, bottom ash, economizer ash, or ponded ash. In some embodiments, the feedstock siliceous material comprises a clay. In some embodiments, the feedstock siliceous material comprises a natural mineral, mining tailings, acid leached materials, and/or base leached materials. In some embodiments, the feedstock includes a blend of siliceous materials from two or more sources to produce a product siliceous material with desired properties. In some embodiments, the processed siliceous material has a strength activity index of at least 75, and a water requirement of at most 115% of an OPC control when blended into OPC at 20% mass in a cement mortar. In some embodiments, the method includes preprocessing the feedstock siliceous material to remove impurities. In some embodiments, the preprocessing comprises contacting the feedstock siliceous material with an acid. In some embodiments, the acid is selected from the group consisting of hydrochloric acid, nitric acid, sulfuric acid, acetic acid, oxalic acid, lactic acid, and formic acid. In some embodiments, the dissolving is performed in a reactor, and wherein the feedstock siliceous material entering the reactor contains less than 5 wt. % of any impurities. In some embodiments, the impurities are selected from the group consisting of calcium, magnesium, iron, or combinations thereof. In some embodiments, the dissolving of the feedstock siliceous material occurs in a processing mixture, and wherein the dissolving comprises decreasing the activity of ammonia in the processing mixture and/or increasing the temperature of the processing mixture. In some embodiments, the precipitating of the processed siliceous material occurs in a processing mixture, and wherein the precipitating comprises increasing the activity of ammonia in the processing mixture, decreasing the temperature of the processing mixture, and/or adding acid to the processing mixture. In some embodiments, the processed siliceous material comprises a plurality of particles. In some embodiments, the method includes fractionating the particles according to particle size. In some embodiments, the fractionating is accomplished using filtration, elutriation, gravity separation, centrifugal force, or any combination thereof. In some embodiments, the precipitating comprises precipitating the dissolved feedstock siliceous material in the presence of a plurality of seed particles, such that the processed siliceous material has a mass weighted median particle diameter of between 1 and 10 micrometers. In some embodiments, the method includes removing the fluoride-containing compound and/or hydroxide-containing compound from the processed siliceous material. In some embodiments, the fluoride-containing compound and/or hydroxide-containing compound is removed from the processed siliceous material by washing the processed siliceous material, followed by compressed gas blowing or evacuation. In some embodiments, the method includes drying the processed siliceous material. In some embodiments, the drying of the processed siliceous material is performed using flash drying, rotary drying, spray drying, heating, vacuum, or any combination thereof. In some embodiments, the feedstock siliceous material comprises alumina or aluminum hydroxide. In some embodiments, the method comprises selectively precipitating alumina or aluminum hydroxide separately. In some embodiments, the processed siliceous material comprises less than 40 wt. % alumina or aluminum hydroxide. In some embodiments, the processed siliceous material comprises at least 5 wt. % alumina or aluminum hydroxide. In some embodiments, the processed siliceous material comprises a plurality of particles, wherein each particle comprises a silica core surrounded by an alumina or aluminum hydroxide shell. In some embodiments, the method includes recovering at least 90% of the fluoride-containing compound and/or hydroxide-containing compound. In some embodiments, the method includes dissolving a plurality of feedstock siliceous materials, wherein each feed stock siliceous material of the plurality of feedstock materials is different.

In some embodiments, a processed siliceous material can be prepared by any of the above methods.

In some embodiments, a processed siliceous material can have a strength activity index of at least 75, and a water requirement of at most 115% of an OPC control when blended in to OPC at 20% mass in a cement mortar. In some embodiments, the processed siliceous material comprises a plurality of particles. In some embodiments, the processed siliceous material has a mass weighted median particle diameter between 1 and 10 micrometers. In some embodiments, the processed siliceous material comprises less than 2 wt. % fluorine. In some embodiments, the processed siliceous material comprises less than 40 wt. % alumina or aluminum hydroxide. In some embodiments, the processed siliceous material comprises at least 5 wt. % alumina or aluminum hydroxide. In some embodiments, the processed siliceous material comprises a plurality of particles, wherein each particle comprises a silica core surrounded by an alumina or aluminum hydroxide shell.

In some embodiments, a cementitious material can include any of the above processed siliceous materials. In some embodiments, the cementitious material is a pozzolanic cement.

Additional advantages will be readily apparent to those skilled in the art from the following detailed description. The examples and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF FIGURES

The invention will now be described, by way of example only, with reference to the accompanying drawings, in which:

FIG. 1 illustrates a first exemplary system for processing siliceous materials, in accordance with some embodiments disclosed herein.

FIG. 2 illustrates a second exemplary system for processing siliceous materials, in accordance with some embodiments disclosed herein.

FIG. 3 illustrates a third exemplary system for processing siliceous materials, in accordance with some embodiments disclosed herein.

### DETAILED DESCRIPTION

Ammonium fluoride (NH₄F) or ammonium bifluoride (NH₄HF₂) or acid ammonium fluoride (3NH₄·HF₂), or disodium fluorophosphate (Na₂PO₃F), or mixtures, solutions, and derivatives thereof, collectively referred to as AF, may be used as a component or additive in a siliceous material (including silicates or silicate-bearing compounds) for use in a cementitious material or application, or as a component or in a process for treating siliceous materials for use in a cementitious material or application. Without being bound by any particular scientific interpretation, Applicant believes that AF can dissolve, partially dissolve, or otherwise react with the whole or part of solid siliceous compounds, thereby increasing the reactivity and/or flowability of said silicate-bearing solids and improving their ability to participate in cementitious reactions, including but not limited to reactions important to the formation and processing of construction materials. Compared to other chemical reagents that may dissolve silicates such as hydrofluoric acid (HF), AF can have the advantage of lower toxicity and greater safety than HF.

Alkali metal hydroxides such as sodium hydroxide (NaOH) or potassium hydroxide (KOH), or mixtures, solutions, and derivatives thereof, collectively referred to as AMH, may be used as a component or additive in a siliceous material (including silicates or silicate-bearing compounds) for use in a cementitious material or application, or as a component or in a process for treating siliceous materials for use in a cementitious material or application. Without being bound by any particular scientific interpretation, Applicant believes that AMH can dissolve, partially dissolve, or otherwise react with the whole or part of solid siliceous compounds, thereby increasing the reactivity and/or flowability of said silicate-bearing solids and improving their ability to participate in cementitious reactions, including but not limited to reactions important to the formation and processing of construction materials.

References made to particular examples and implementations are for illustrative purposes and are not intended to limit the scope of the claims. The following description of the embodiments of the invention is not intended to limit the invention to these embodiments but rather to enable a person skilled in the art to make and use this invention.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

The following examples are provided to illustrate various embodiments of the present systems and methods of the present inventions. These examples are for illustrative purposes, may be prophetic, and should not be viewed as limiting, and do not otherwise limit the scope of the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories may not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular figure.

In one aspect provided herein are methods for processing siliceous materials comprising dissolving a feedstock siliceous material in the presence of a fluoride-containing compound and/or a hydroxide-containing compound and precipitating the dissolved feedstock siliceous material to provide a processed siliceous material. In some embodiments, the fluoride-containing compound is AF. In some embodiments, the fluoride-containing compound is selected from the group consisting of ammonium fluoride (NH₄F), ammonium bifluoride (NH₄HF₂), acid ammonium fluoride (3NH₄·HF₂), and disodium fluorophosphate (Na₂PO₃F), or mixtures, solutions, and derivatives thereof. In some embodiments, the fluoride containing compound is not hydrofluoric acid. In some embodiments, the hydroxide-containing compound is AMH. In some embodiments, the hydroxide-containing compound is selected from the group consisting of NaOH and KOH, or mixtures, solutions, and derivates thereof.

In one aspect, provided is a method for producing a cementitious material, comprising reacting (i) a feedstock siliceous material with (ii) a fluoride-containing compound or a hydroxide-containing compound to form an intermediate that is at least partially dissolved and to simultaneously produce a gaseous species, increasing the activity or partial pressure of the gaseous species to reverse the dissolution reaction, thereby precipitating a processed siliceous material, and regenerating the fluoride-containing compound or the hydroxide-containing compound, and combining the processed siliceous material with hydrated lime and water to produce a cementitious material.

In one aspect, provided herein is a method for producing a processed siliceous material, comprising reacting (i) a feedstock siliceous material with (ii) a fluoride-containing compound under conditions suitable to dissolve a portion of the feedstock siliceous material and leave the remaining portion of the feedstock siliceous material undissolved, and heterogeneously precipitating the dissolved portion of the feedstock siliceous material onto the undissolved portion of the feedstock siliceous material, to produce a processed siliceous material.

In one aspect, provided herein is a method for producing processed siliceous material, comprising reacting (i) a feedstock siliceous material with (ii) a fluoride-containing compound or a hydroxide-containing compound under suitable conditions to at least partially dissolve the feedstock siliceous material, and precipitating the dissolved feedstock siliceous material via homogeneous and/or heterogenous precipitation to produce a processed siliceous material that has a high specific surface area of disordered silicate or aluminum silicate, and a high bulk density. In some embodiments, the dissolved feedstock is heterogeneously precipitated in the presence of silica seed particles. In some embodiments, the dissolved feedstock is heterogeneously precipitated in the presence of undissolved feedstock siliceous material. In some embodiments, the precipitating step is controlled to first homogenously precipitate a portion of the dissolved feedstock, followed by heterogeneously precipitating remaining dissolved feedstock. In some embodiments, the method comprises combining the processed siliceous material with hydrated lime and water to produce a cementitious material.

In some embodiments of any of the foregoing aspects or embodiments, the precipitation step occurs under suitable conditions to produce processed siliceous material having amorphous form, a bulk density of between 0.5 g/cm² and 2.5 g/cm², a specific surface area of between 1 m²/g and 100 m²/g, or a mass weighted median diameter of between 1 and 10 micrometers, a strength activity index of at least 75, and a water requirement of at most 115% of an OPC control when blended in to OPC at 20% mass in a cement mortar, or any combination of the foregoing.

In some embodiments of any of the foregoing aspects or embodiments, the method further comprises preprocessing the feedstock siliceous material to remove at least a portion of calcium, magnesium, iron, or combinations thereof.

In some embodiments of any of the foregoing aspects or embodiments, the feedstock siliceous material is reacted with a fluoride-containing compound. In some embodiments, the fluoride-containing compound comprises ammonium and fluoride. In some embodiments, the fluoride-containing compound is NH₄F, NH₄HF₂, or 3NH₄·HF₂, or any combination thereof.

In some embodiments of any of the foregoing aspects or embodiments, the feedstock siliceous material is reacted with a hydroxide-containing compound.

In some embodiments of any of the foregoing aspects or embodiments, the gaseous species comprises ammonia.

In some embodiments of any of the foregoing aspects or embodiments, the feedstock siliceous material has at least 10% silica or silicon by mass, and a minimized calcium, magnesium, and iron content.

In one aspect, provided is a method for producing a cementitious material, comprising reacting (i) a feedstock siliceous material with (ii) a hydroxide-containing compound to form an intermediate that is at least partially dissolved and to simultaneously produce a gaseous species, and increasing the activity or partial pressure of the gaseous species to reverse the dissolution reaction, thereby precipitating a processed siliceous material, and regenerating the hydroxide-containing compound. In some embodiments, the method further comprises combining the processed siliceous material with hydrated lime and water to produce a cementitious material.

In one aspect, provided is a processed siliceous material having one or more of the following properties: amorphous form; a bulk density of between 0.5 g/cm² and 2.5 g/cm²; a specific surface area of between 1 m²/g and 100 m²/g; a mass weighted median diameter of between 1 and 10 micrometers; strength activity a strength activity index of at least 75, and a water requirement of at most 115% of an OPC control when blended in to OPC at 20% mass in a cement mortar.

In some embodiments of any of the aspects or embodiments disclosed herein, the method does not require the processed siliceous material to have a purity greater than 99 wt. % for combining with hydrated lime and water to produce a cementitious material. In some embodiments, the purity of silica and/or silicate in the processed siliceous material is not greater than 99 wt. %. In some variations, the purity of silica and/or silicate in the processed siliceous material is between about 50 wt. % and about 99 wt. %, about 50 wt. % and about 98 wt. %, about 50 wt. % and about 97 wt. %, about 50 wt. % and about 96 wt. %, about 50 wt. % and about 95 wt. %, about 50 wt. % and about 90 wt. %, about 50 wt. % and about 85 wt. %, or about 50 wt. % and about 80 wt. %. In some embodiments, the processed siliceous material has more than 1 wt. % total of elements other than silicon and oxygen. In some variations, total proportion of elements other than silicon and oxygen in the processed siliceous material is between about 1 wt. % and about 50 wt. %, about 2 wt. % and about 50 wt. %, about 3 wt. % and about 50 wt. %, about 4 wt. % and about 50 wt. %, about 5 wt. % and about 50 wt. %, about 10 wt. % and about 50 wt. %, about 15 wt. % and about 50 wt. or about 20 wt. % and about 50 wt. %. In some variations, a total proportion of elements other than silicon and oxygen in the processed siliceous material is at least 1 wt. %, at least 2 wt. %, at least 3 wt. %, at least 4 wt. %, at least 5 wt. %, at least 10 wt. %, at least 15 wt. %, or at least 20 wt. %. In some variations, a total proportion of elements other than silicon and oxygen in the processed siliceous material is at most 50 wt. %, at most 40 wt. %, at most 30 wt. %, at most 20 wt. %, at most 15 wt. %, at most 10 wt. %, or at most 5 wt. %.

As referred to herein, AF or AMH may comprise a solid compound or mixtures of solid compounds, a melt or partially molten form of said solid compounds, or AF or AMH that is dissolved in a liquid, said liquid comprising water, a polar solvent, a non-polar solvent, or a mixture of said solvents. The dissolved concentration of AF in the liquid solvent may range from a lower bound of 0.001 M to an upper bound of 20 M, 0.01 M to 10 M, or 0.01 M to 5 M. The dissolved concentration of AMH in the liquid solvent may range from a lower bound of 0.1 M to an upper bound of 30 M, 1 M to 15 M, or 2 M to 10 M. In some embodiments, the AF is dissolved in a liquid solvent, and the dissolved concentration of AF is at least about 0.01 M, about 0.02 M, about 0.03 M, about 0.04 M, about 0.05 M, about 0.1 M, about 0.2 M, about 0.3 M, about 0.4 M, about 0.5 M, about 0.6 M, about 0.7 M, about 0.8 M, about 0.9 M, about 1 M, about 1.5 M, about 2 M, about 2.5 M, about 3 M, about 3.5 M, about 4 M, about 4.5 M, or about 5 M. In some embodiments, the AF is dissolved in a liquid solvent, and the dissolved concentration of AF is at most about 0.01 M, about 0.02 M, about 0.03 M, about 0.04 M, about 0.05 M, about 0.1 M, about 0.2 M, about 0.3 M, about 0.4 M, about 0.5 M, about 0.6 M, about 0.7 M, about 0.8 M, about 0.9 M, about 1 M, about 1.5 M, about 2 M, about 2.5 M, about 3 M, about 3.5 M, about 4 M, about 4.5 M, or about 5 M. In some embodiments, the AMH is dissolved in a liquid solvent, and the dissolved concentration of AMH is at least about 0.1 M, about 0.2 M, about 0.3 M, about 0.4 M, about 0.5 M, about 1 M, about 2 M, about 3 M, about 4 M, about 5 M, about 6 M, about 7 M, about 8 M, about 9 M, about 10 M, about 15 M, about 20 M, about 25 M, or about 30 M. In some embodiments, the AMH is dissolved in a liquid solvent, and the dissolved concentration of AMH is at about 0.1 M, about 0.2 M, about 0.3 M, about 0.4 M, about 0.5 M, about 1 M, about 2 M, about 3 M, about 4 M, about 5 M, about 6 M, about 7 M, about 8 M, about 9 M, about 10 M, about 15 M, about 20 M, about 25 M, or about 30 M.

In some embodiments, dissolving the feedstock siliceous material in AF and/or AMH comprises adding AF and/or AMH to, combining AF and/or AMH with, or reacting AF and/or AMH with, a siliceous material, wherein the siliceous material is the feedstock siliceous material. Said siliceous materials to which said AF and/or AMH is added or combined may span a wide range of earth minerals and rocks which comprise silicate, and which have various classification schemes and names. According to one classification scheme, said siliceous materials may have an oxygen/silicon ratio in the range of about 2 to about 4, including without limitation silica (including quartz, cristobalite, tridymite, fused silica, amorphous silica, or fumed silica), layered silicates (including clays, kaolin, metakaolin, kaolinite, pyrophyllite, mica, talc, montmorillonite, vermiculite), amphiboles (asbestos minerals), pyroxenes, beryls, pyrosilicates, and orthosilicates (olivine, forsterite, zircon). According to another classification scheme, said siliceous materials may range from those that contain SiO₄ structural units joined in patterns ranging from three dimensionally connected arrays, to sheets, to fibers, to isolated SiO₄ units. These classes of silicates can include tectosilicates, phyllosilicates, inosilicates, cyclosilicates, sorosilicates, or nesosilicates. Said siliceous materials may include those that are commonly described by various mineral and rock names, including without limitation olivines, feldspars, clays, basalts, granites, sandstone, garnet, mullite, wollastonite, pumice, volcanic ash, and the like. In some embodiments, the siliceous material of interest is a pozzolan. In some embodiments, the siliceous material of interest comprises both calcium and silicon. In other embodiments, said silicates comprise sand or aggregate used in preparing mortar or concrete, including crushed or recycled concrete, bricks, mortar, stone, or other such construction materials.

“Silicate”, as used herein, refers to any compound comprising at least silicon and oxygen.

Said siliceous materials to which said AF and/or AMH is added or combined may include byproducts of other manufacturing or industrial processes. Such materials may include ashes, including without limitation fly ash, bottom ash, ponded ash, incinerator ash, wood ash, or agricultural waste ash (including rice hull ash). Such ashes may include those produced by combustion processes in power plants, including coal-fired or natural gas fired power plants, or in municipal solid waste incinerators. Said siliceous materials can also include slags, including without limitation slags used in steel-making such as blast furnace slag, electric arc furnace slag, and basic oxygen furnace slag. Other possible slags can include slags from magnesium and copper production. Other industrial byproducts may include tailings from mining processes or red mud generated from the Bayer Process. Mining tailings may include tailings from processes where materials were leached with acid or base to extract non-silica components.

In some embodiments, the method comprises using the processed siliceous material to produce a product. Products resulting from the modification or treatment of siliceous materials with AF and/or AMH include but are not limited to cementitious materials, and construction materials. Said cementitious materials include cements or cement pastes comprising a hydrated silicate. Said hydrated silicate may include an alkali or alkaline earth element, including calcium silicate hydrate (CSH), calcium aluminum silicate hydrate (CASH), hydrated silicates comprising sodium or potassium, and hydrated silicate gels known as geopolymers. Such phases can also be known as cement binder phases. Said cementitious materials can also include Portland cement, or other cements which comprise calcium silicates, in particular tricalcium silicate (Ca₃SiO₅) in the alite phase and/or dicalcium silicate (Ca₂SiO₄) in the belite phase. Said cements can also comprise pozzolanic cements such as lime-pozzolan cements. Said pozzolanic cements comprise at least 50 wt. % of the combination of lime (quicklime, CaO, and/or hydrated lime, Ca(OH)₂) and at least one pozzolan (a reactive silicate or aluminosilicate).

Products described herein also can comprise cement mortars, here understood to mean a mixture comprising cement paste and other constituents such as sand, and concrete, here understood to mean a mixture comprising cement paste and coarser matter such as gravel or crushed rock, often referred to as aggregate. The products can also comprise reinforced cement or concrete, wherein said reinforcement may comprise whiskers, fibers, wires, meshes, rods, or plates of a reinforcement materials. Said reinforcement materials may comprise steel (for example, “rebar” or reinforcement bar) or a polymer (for example, chopped polymer fibers or mesh).

In some embodiments, AF and/or AMH is added as a constituent (that is, a component or additive) to a mixture comprising one or more of the above-described siliceous materials, in order to dissolve or partially dissolve said siliceous material and thereby facilitate its participation in a reaction that at least in part forms a cementitious material. The AF and/or AMH may be added as a dry solid or as a dissolved component in solution.

In the instance where the AF and/or AMH is added as a dry solid, the solid may be a fine powder (including powder having a mass weighted median particle diameter between 0.01 and 100 micrometers), a coarse powder (particulates having a mass weighted median particle diameter between 100 micrometers and 5 millimeters), or pellets (objects with average dimensions between 5 millimeters and 1 centimeter), or larger pieces (objects with average dimensions greater than 1 centimeter). The dry AF and/or AMH may comprise a coating on another constituent of the mixture which subsequently forms a cementitious material. The AF and/or AMH may also be added as a moist or wet gel, paste, or slurry to the mixture. Water may be subsequently added in the process of making said cementitious material, including to dissolve and distribute the AF and/or AMH within the mixture. Subsequently, the dissolution or partial dissolution of the siliceous material by the AF and/or AMH can facilitate the formation of cementitious phases. For example, the addition of AF and/or AMH in this manner may increase the rate of formation of CSH, CASH, or geopolymers.

The AF and/or AMH may also be added as a fully or partially dissolved component in a liquid solution to the siliceous material. For example, said solution may be added to the siliceous material and optionally other constituents to form a cement paste or slurry, a mortar, or concrete mixture. Subsequently, the dissolution or partial dissolution of the siliceous material by the AF and/or AMH can facilitate the formation of cementitious phases. For example, the addition of AF and/or AMH in this manner may increase the rate of formation of CSH, CASH, or geopolymers.

It is understood that the reaction of AF with silica, SiO₂, may form various intermediate compounds, including ammonium silicofluoride ((NH₄)₂SiF₆), silicon tetrafluoride (SiF₄) and/or hexafluorosilicic acid (H₂SiF₆). In some embodiments, an acid is added to accelerate the reaction to form (NH₄)₂SiF₆. Examples of such acids include, but are not limited to, hydrofluoric acid (HF), hydrosilicofluoric acid (H₂SiF₆) or sulfuric acid (H₂SO₄). The ratio of AF to acid may vary widely. For example, in the instance where NH₄F is used in combination with H₂SO₄, the molar ratio NH₄F:H₂SO₄ may be greater than one or less than one, may be about 3:1, or may have a large excess of sulfuric acid such that the ratio is as low as 0.001:1. Without being bound by any particular scientific interpretation, the dissolution of SiO₂ to form such intermediates, followed by the precipitation of a disordered, highly reactive SiO₂ upon hydrolysis, addition of a base, or exposure to ammonia, may be a reaction pathway used herein. In particular, the high pH environment of hydraulic cements promotes such reactions which render SiO₂ insoluble. Accordingly, in some embodiments, the reaction of silica with AF may be carried out in a separate step prior to the addition of high pH constituents of the cementitious such as lime, slaked lime, portland cement, or alkaline hydroxides (for example, NaOH or KOH). The reaction of silica or silicate with AF may be carried out at a pH below about 10, and more specifically, for the ammonium fluorides, at a pH between about 1 and about 8, and for disodium fluorophosphate, at a pH between about 6 and about 10. In other embodiments, the addition of water to a mixture of AF, the siliceous material and alkaline constituents can allow the silica dissolution reaction to occur locally within the mixture, followed by a silica precipitation reaction or the formation of cement binder phases as the pH is raised throughout the cementitious material.

It is understood that in some cementitious materials and applications, excess free fluoride (F−) is undesirable. Accordingly, in some embodiments, the composition of the cementitious mixture can be selected to allow the fluoride ion to be captured as a solid fluoride. As a non-limiting example, calcium may be used to remove fluoride through the formation of solid CaF₂, calcium fluoride. For example, said calcium may be provided by having, as a constituent of the cementitious material, lime or slaked lime or Portland cement or other source of calcium. Accordingly, in some embodiments, AF can be present in a mixture comprising siliceous materials, and the fluorine is at least partially converted to solid fluoride. In some embodiments, the solid fluoride can comprise calcium, and may be CaF₂ or a mixed metal fluoride comprising calcium. Said calcium-comprising fluoride may be formed by the addition of a calcium-bearing mixture to said silicate bearing mixture. In some embodiments, said calcium-bearing mixture comprises one or more of lime (CaO), slaked lime (Ca(OH)₂), Portland cement, a calcium silicate, wollastonite, basalt or other calcium silicate mineral.

In the compositions of the invention, the amount of AF may vary according to the type of siliceous material, the amount of silica dissolution desired, the requirements of the cementitious material for its application, the cost of the mixture, and other factors. In general, between 4 and 8 moles of fluorine may be required dissolve one mole of Si. However, it may not be necessary or advantageous to fully dissolve the silica in order to “activate” cementitious reactions. Accordingly, the molar ratio of fluorine in the AF to Si in the siliceous material may vary over a wide range, from as high as 8 to as low as 0.001.

A wide variety of siliceous materials can be used in cementitious construction materials such as cements, cement mortars, and concretes. Such siliceous materials may benefit from greater reactivity of the silica with other components in the cementitious mixture, for example during setting and curing and strength development. In the manufacture of portland cement, the reactivity of lime and silica during high temperature firing can be important to the energy-efficient production of clinker with desired properties. For pozzolanic cements, the reactivity of the pozzolan, which is the primary siliceous phase of matter used, can be critical to the development of properties during hydration and reaction. For supplemental cementitious materials (SCM) such as ashes and slags, the reactivity of the SCM in the cementitious mixture can be a key selection criterion. In mortars and in concrete, the reactivity of the non-cement paste materials, such as sand, gravel, and aggregate, can affect the bonding between the cement paste and the aggregate. Many siliceous materials have not found widespread use in cement and concrete despite their low cost and abundance, due to insufficient reactivity. As one non-limiting example, while fly ash from coal-fired power plants is widely used as an SCM, bottom ash is not, largely due to its limited reactivity. As another example, clays must typically be calcined in order to increase their reactivity for use in cements.

As described herein, siliceous materials may be treated to increase their reactivity and suitability for cementitious applications by treating with AF and/or AMH. Without being bound by any particular scientific interpretation, treating with AF and/or AMH may have the effect of dissolving and then precipitating or reprecipitating silica in a more reactive or more soluble form that is generally disordered or amorphous or finely divided than the starting material, increasing the reactivity of the siliceous material. The fraction or percentage of the siliceous material that is affected by treatment with AF and/or AMH may vary widely. In some embodiments, a finely divided siliceous material such as a fine ash or pumice may be almost entirely dissolved and reprecipitated in a more reactive form. For sand used in a mortar, or aggregate used in concrete, greater strength of the final product may be obtained by treating the surface of the sand to form a highly reactive silicate surface.

In some embodiments, a clay material can be subjected to a partial dissolution treatment to improve its reactivity and suitability for use in cement without needing to calcine the clay, or reducing the temperatures and/or times under which the clay is calcined prior to its use in a cementitious mixture. Depending on the conditions of the reaction and the desired extent of dissolution and precipitation, the molar ratio of AF and/or AMH to silica entering the dissolution process may range from 0.001 to 8, 0.001 to 1, 1 to 3, or 3 to 8.

The siliceous material may contain aluminum in the form of aluminosilicates, aluminum hydroxide, alumina, other aluminum salt, or combinations thereof. Addition of AF and/or AMH can induce complete, partial, or preferential dissolution of the aluminum species and/or complete, partial or preferential dissolution of the silica species thereby creating a processed material with a greater concentration of aluminum or silica when compared to the feed material. Depending on the conditions of the reaction and the desired extent of dissolution and precipitation, the molar ratio of AF and/or AMH to alumina entering the dissolution process may range from 0.001 to 8, 0.001 to 1, 1 to 3, or 3 to 8.

In some embodiments, the AF and/or AMH that is used to treat the siliceous material can be used once and discarded or remediated or recycled after use. However, in some embodiments, a closed-loop process can be used wherein the AF and/or AMH can be regenerated and reused, decreasing or eliminating the need to supply additional AF and/or AMH to process more material. Examples of such a process is now described, which may be conducted in a batch manner or as a continuous process.

Considering the use of NH₄F as the AF, a multi-stage reactor may have a first stage in which silica is dissolved. Without being bound by any particular scientific interpretation, the dissolution reaction can be one which produces ammonia as a product, for example according to the reaction:

SiO₂+6NH₄F→(NH₄)₂SiF₆+2H₂O+4NH₃ (1)

Such reaction may be carried out in the temperature range from about 25° C. to about 110° C. To promote the forward reaction, the activity of the ammonia reaction product can be decreased. This may be done by separating the ammonia from the water by well-known methods, for example by distillation which takes advantage of the higher vapor pressure of ammonia.

In a second stage of the reactor, reaction (1) can reversed by increasing the activity of ammonia. An excess of the stoichiometric ratio of ammonia to ammonium silicofluoride of 4:1 may be desirable. Thus, SiO₂ can be reprecipitated, and NH₄F can be produced. The solid precipitated SiO₂, along with any solid matter that was not dissolved during the process or which was simultaneously dissolved and precipitated, may subsequently be separated from the liquid, for example by filtering or centrifugal separation, optionally rinsed or dried, and used in making a cementitious material.

Another possible reaction for which a similar reaction scheme may be used is:

SiO₂+6NH₄F→H₂SiF₆+2H₂O+6NH₃ (2)

As another example, consider the use of ammonium bifluoride, NH₄HF₂ in a similar scheme. Ammonium bifluoride may dissolve silica according to the reaction:

SiO₂+4N₄HF₂→(NH₄)₂SiF₆+2NH₄F+2H₂O (3)

Or:

SiO₂+4N₄HF₂→SiF₄+4NH₄F+2H₂O (4)

Or:

SiO₂+3N₄HF₂→H₂SiF₆+3NH₃+2H₂O (5)

With reaction 5, a similar reaction scheme to that described above for ammonium fluoride may be used to dissolve SiO₂ and reprecipitate it as a more reactive silicate

Considering the use of NaOH as the AMH, a multi-stage reactor may have a first stage in which silica is dissolved. Without being bound by any particular scientific interpretation, the dissolution reaction can proceed, for example, according to the reaction:

SiO₂+2NaOH→Na₂SiO₃+H₂O (6)

Such reaction may be carried out in the temperature range from about 100° C. to about 400° C. To promote the forward reaction, the temperature of the reaction can be increased.

In a second stage of the reactor, SiO₂ can be reprecipitated by addition of an acid such as CO₂ according to for example the following reaction:

Na₂SiO₃+CO₂→Na₂CO₃+SiO₂ (7)

In some embodiments, CO₂ and NaOH can be regenerated through a process involving a calciner and/or electrolyzer. Thus, SiO₂ can be reprecipitated, and Na₂CO₃ can produced. The solid precipitated SiO₂, along with any solid matter that was not dissolved during the process or which was simultaneously dissolved and precipitated, may subsequently be separated from the liquid, for example by filtering or centrifugal separation, optionally rinsed or dried, and used in making a cementitious material. The by-product Na₂CO₃ may be regenerated and recycled back into the process, for example, by CO₂ extraction with lime followed by calcination or by utilization of an electrolyzer.

Considering the use of NaOH as the AMH, a multi-stage reactor may have a first stage in which alumina is dissolved. Without being bound by any particular scientific interpretation, the dissolution reaction can proceed, for example, according to the reaction:

Al₂O₃+2NaOH+3H₂O→2NaAl(OH)₄ (8)

Such reaction may be carried out in the temperature range from about 100° C. to about 300° C. To promote the forward reaction, the temperature of the reaction can be increased.

In a second stage of the reactor, Al₂O₃ can be reprecipitated by cooling of the sodium aluminate containing mixture according to for example the following reaction:

2NaAl(OH)₄→2Al(OH)₃+2NaOH (9)

Thus, the aluminum can reprecipitated either as an alumina, aluminum hydroxide, aluminosilicate, or combinations thereof. The solid precipitated aluminum salt, along with any solid matter that was not dissolved during the process or which was simultaneously dissolved and precipitated, may subsequently be separated from the liquid, for example by filtering or centrifugal separation, optionally rinsed or dried, and used in making a cementitious material.

Some embodiments, the methods disclosed herein may include a combination of silica and alumina dissolution and precipitation. In some cases, the conditions are such to generate a product with an enhanced concentration of silica and/or an enhanced concentration of aluminum salts. In some embodiments, the reactions may be temporally and/or spatially arranged to generate particles with layers or other non-homogeneous construction that can preferentially locate silica and/or aluminum salts near the surface of the particles.

Embodiments disclosed herein include the above described methods for dissolving and reprecipitating a silicate in whole or in part for use in a cementitious mixture. In some embodiments, the method comprises dissolving less than 100 wt. %, less than about 90 wt. 00 less than about 80 wt. %, less than about 70 wt. %, less than about 60 wt. %, less than about 50 wt. %, less than about 40 wt. %, less than about 30 wt. %, less than about 20 wt. %, or less than about 10 wt. % of the feedstock siliceous material. In some embodiments, the method comprises dissolving less than about 25 wt. % of the feedstock siliceous material. In some embodiments, the method comprises dissolving between about 1 wt. % and 100 wt. 00 between about 1 wt. % and about 90 wt. %, between about 1 wt. % and about 80 wt. %, between about 1 wt. % and about 70 wt. % between about 1 wt. % and about 60 wt. %, between about 1 wt. % and about 50 wt. %, between about 1 wt. % and about 40 wt. %, between about 1 wt. % and about 30 wt. %, between about 1 wt. % and about 25 wt. %, between about 1 wt. % and about 20 wt. %, between about 1 wt. % and about 15 wt. %, between about 1 wt. % and about 10 wt. %, between about 1 wt. % and about 5 wt. %, between about 5 wt. % and about 25 wt. %, between about 5 wt. % and about 20 wt. %, between about 5 wt. % and about 15 wt. %, between about 5 wt. % and about 10 wt. %, between about 10 wt. % and about 25 wt. %, between about 10 wt. % and about 20 wt. %, between about 10 wt. % and about 15 wt. %, between about 15 wt. % and about 25 wt. %, between about 15 wt. % and about 20 wt. %, or between about 20 wt. % and about 25 wt. % of the feedstock siliceous material. In some embodiments, the method comprises dissolving between about 20 wt. % and 50 wt. % of the feedstock siliceous material. In some embodiments, the method comprises dissolving between about 5 wt. % and 20 wt. % of the feedstock siliceous material. In some embodiments, the method comprises dissolving between about 50 wt. % and about 90 wt. %. In some embodiments, the method comprises dissolving between about 90 wt. % and about 99.9 wt. %.

Some feedstock siliceous materials may contain impurities that could react with AF and/or AMH to form insoluble precipitates. Such impurities could present at least two problems. First, in some cases, the aforementioned insoluble precipitates could be difficult to separate from the processed siliceous material. This could lead to the presence of these precipitates in the processed siliceous materials, which can negatively impact their properties with respect to certain applications. Such negative impacts could include a reduction in pozzolanic reactivity, a reduction in flowability, and/or an increase of fluoride in the final cement or concrete product that exceeds a permissible limit present in a standard, code, regulation, or guideline. Alternatively, removal of such precipitates from the processed siliceous materials may involve additional processing steps, thereby adding undesirable time and energy requirements to the overall process. Second, in some cases, the insoluble precipitates could be formed when the impurities react with one or more components of AF and/or AMH. For example, an impurity could react with the fluoride ion component of AF to form an insoluble fluoride precipitate. In such cases, the removal of AF from the system may eventually require additional AF to be added to the system, resulting in increased material requirements and costs.

Accordingly, in some embodiments, the method comprises preprocessing the material to remove impurities. In some embodiments, the preprocessing comprises contacting the feedstock siliceous material with an acid. In some embodiments, the acid is selected from the group consisting of hydrochloric acid, nitric acid, sulfuric acid, acetic acid, oxalic acid, lactic acid, formic acid, or combinations thereof. In some embodiments, the impurities are selected from the group consisting of calcium, magnesium, iron, or combinations thereof. In some embodiments, the feedstock siliceous material comprises less than about 5 wt. % impurities after being preprocessed. In some embodiments, the feedstock siliceous material comprises less than about 10 wt. %, less than about 9 wt. %, less than about 8 wt. %, less than about 7 wt. %, less than about 6 wt. %, less than about 5 wt. %, less than about 4 wt. %, less than about 3 wt. %, less than about 2 wt. %, less than about 1 wt. %, less than about 0.5 wt. %, less than about 0.4 wt. %, less than about 0.3 wt. %, less than about 0.2 wt. %, less than about 0.1 wt. %, less than about 0.05 wt. %, or less than about 0.01 wt. % of impurities after being preprocessed. In some embodiments, the feedstock siliceous material can include greater than or equal to about 10 wt. %, greater than or equal to about 9 wt. %, greater than or equal to about 8 wt. %, greater than or equal to about 7 wt. %, greater than or equal to about 6 wt. %, greater than or equal to about 5 wt. %, greater than or equal to about 4 wt. %, greater than or equal to about 3 wt. %, greater than or equal to about 2 wt. %, greater than or equal to about 1 wt. %, greater than or equal to about 0.5 wt. %, greater than or equal to about 0.4 wt. %, greater than or equal to about 0.3 wt. %, greater than or equal to about 0.2 wt. %, greater than or equal to about 0.1 wt. %, greater than or equal to about 0.05 wt. %, or greater than or equal to about 0.01 wt. % of impurities before being preprocessed.

In some embodiments, the dissolving of the feedstock siliceous material occurs in a processing mixture, and the dissolving comprises decreasing the activity of ammonia in the processing mixture. In some embodiments, the dissolving comprises decreasing the concentration of ammonia in the processing mixture. In some embodiments, the dissolving comprises increasing the temperature of the processing mixture (e.g., the hydroxide-containing solution).

In some embodiments, the method comprises precipitating about 100% of the dissolved feedstock siliceous material. In some embodiments, the method comprises precipitating greater than about 99% of the dissolved feedstock siliceous material. In some embodiments, the method comprises precipitating greater than about 95% of the dissolved feedstock siliceous material.

In some variations, heterogeneous precipitation involves a precipitation process wherein a compound dissolved in solution precipitates by depositing onto a preexisting surface. In some variations, homogeneous precipitation involves a precipitation process wherein a compound dissolved in solution precipitates to form a new particle. In some variations, homogeneous precipitation involves the spontaneous nucleation of new precipitate particles from dissolved compounds in solution.

In some embodiments, the precipitating comprises heterogeneously precipitating the dissolved feedstock siliceous material onto an undissolved portion of the feedstock siliceous material. In some embodiments, the method comprises dissolving a portion of the feedstock siliceous material, and heterogeneously precipitating the dissolved feedstock siliceous material onto an undissolved portion of the feedstock siliceous material. Methods of processing siliceous materials wherein a portion of the material is dissolved, and is reprecipitated onto the undissolved portion of the feedstock siliceous material may yield processed siliceous materials having improved properties relative to those produced by completely dissolving the feedstock siliceous material and homogeneously reprecipitating the material. Partial dissolution and reprecipitation as described above may result in the smoothing of rough morphological features on the particles, and an overall densification of the particles, resulting in a processed siliceous material with improved flowability properties. Further, processes wherein the dissolved feedstock siliceous material is reprecipitated heterogeneously, either onto the undissolved portion of the siliceous material, or onto silica seed particles added from an exogenous source, as opposed to homogeneously, may result in improved uniformity in particle size. The size of siliceous particles may affect the pozzolanic reactivity of the material which can be a critical parameter for both short- and long-term cement and/or concrete strength.

Particles that are too small may be difficult to recover using traditional solid/liquid separation techniques. Heterogenous reprecipitation can prevent the formation of small particles that pass through or clog filters or escape separators using gravity, hydrodynamic, or centrifugal forces to concentrate solids.

In some embodiments, the precipitating comprises heterogeneously precipitating the dissolved feedstock siliceous material onto a siliceous material other than the feedstock siliceous material. This could be achieved through recycling a portion of the siliceous product from the process as seed particles for the heterogenous precipitation or adding siliceous seed particles from another source into the reactor where precipitation is occurring. In some embodiments, the precipitating comprises homogeneously precipitating the dissolved feedstock siliceous material.

In some embodiments, the precipitating of the processed siliceous material occurs in a processing mixture, and the precipitating comprises increasing the activity of ammonia in the processing mixture. In some embodiments, the precipitating comprises increasing the concentration of ammonia in the processing mixture.

In some embodiments, the processed siliceous material comprises a plurality of particles.

In some embodiments, the method comprises fractionating the particles according to particle size. In some embodiments, the fractionating is accomplished using filtration, elutriation, gravity separation, centrifugal force, or any combination thereof. In some embodiments, the method comprises fractionating the processed siliceous material to isolate a fraction of the processed siliceous material having a mass weighted median particle diameter of between about 1 and about 10 micrometers. In some embodiments, the method comprises fractionating the processed siliceous material to isolate a fraction of the processed siliceous material having a mass weighted median particle diameter of between about 1 and about 10 micrometers, between about 1 and about 9 micrometers, between about 1 and about 8 micrometers, between about 1 and about 7 micrometers, between about 1 and about 6 micrometers, between about 1 and about 5 micrometers, between about 1 and about 4 micrometers, between about 1 and about 3 micrometers, between about 1 and about 2 micrometers, between about 2 and about 10 micrometers, between about 2 and about 9 micrometers, between about 2 and about 8 micrometers, between about 2 and about 7 micrometers, between about 2 and about 6 micrometers, between about 2 and about 5 micrometers, between about 2 and about 4 micrometers, between about 2 and about 3 micrometers, between about 3 and about 10 micrometers, between about 3 and about 9 micrometers, between about 3 and about 8 micrometers, between about 3 and about 7 micrometers, between about 3 and about 6 micrometers, between about 3 and about 5 micrometers, between about 3 and about 4 micrometers, micrometers, between about 4 and about 10 micrometers, between about 4 and about 9 micrometers, between about 4 and about 8 micrometers, between about 4 and about 7 micrometers, between about 4 and about 6 micrometers, between about 4 and about 5 micrometers, between about 5 and about 10 micrometers, between about 5 and about 9 micrometers, between about 5 and about 8 micrometers, between about 5 and about 7 micrometers, between about 5 and about 6 micrometers, between about 6 and about 10 micrometers, between about 6 and about 9 micrometers, between about 6 and about 8 micrometers, between about 6 and about 7 micrometers, between about 7 and about 10 micrometers, between about 7 and about 9 micrometers, between about 7 and about 8 micrometers, between about 8 and about 10 micrometers, between about 8 and about 9 micrometers, or between about 9 and about 10 micrometers.

In some embodiments, the precipitating comprises precipitating the dissolved feedstock siliceous material in the presence of a plurality of seed particles, such that the processed siliceous material has a mass weighted median particle diameter of between about 1 and about 10 micrometers. In some embodiments, the precipitating comprises precipitating the dissolved feedstock siliceous material in the presence of a plurality of seed particles, such that the processed siliceous material has a mass weighted median particle diameter of between about 1 and about 10 micrometers, between about 1 and about 9 micrometers, between about 1 and about 8 micrometers, between about 1 and about 7 micrometers, between about 1 and about 6 micrometers, between about 1 and about 5 micrometers, between about 1 and about 4 micrometers, between about 1 and about 3 micrometers, between about 1 and about 2 micrometers, between about 2 and about 10 micrometers, between about 2 and about 9 micrometers, between about 2 and about 8 micrometers, between about 2 and about 7 micrometers, between about 2 and about 6 micrometers, between about 2 and about 5 micrometers, between about 2 and about 4 micrometers, between about 2 and about 3 micrometers, between about 3 and about 10 micrometers, between about 3 and about 9 micrometers, between about 3 and about 8 micrometers, between about 3 and about 7 micrometers, between about 3 and about 6 micrometers, between about 3 and about 5 micrometers, between about 3 and about 4 micrometers, micrometers, between about 4 and about 10 micrometers, between about 4 and about 9 micrometers, between about 4 and about 8 micrometers, between about 4 and about 7 micrometers, between about 4 and about 6 micrometers, between about 4 and about 5 micrometers, between about 5 and about 10 micrometers, between about 5 and about 9 micrometers, between about 5 and about 8 micrometers, between about 5 and about 7 micrometers, between about 5 and about 6 micrometers, between about 6 and about 10 micrometers, between about 6 and about 9 micrometers, between about 6 and about 8 micrometers, between about 6 and about 7 micrometers, between about 7 and about 10 micrometers, between about 7 and about 9 micrometers, between about 7 and about 8 micrometers, between about 8 and about 10 micrometers, between about 8 and about 9 micrometers, or between about 9 and about 10 micrometers.

Possible seed particles can include particles comprising aluminum oxide, aluminum hydroxide, silica, combustion ashes, slags, natural minerals including igneous rocks, clays, mining tailings, or combinations thereof. In some embodiments, the seed particles include natural minerals, mining tailings, acid leached materials, and/or base leached materials. In some embodiments, the seed particles can be from metal extraction processes. In some embodiments, the seed particles can be a recycled portion of the product siliceous material. Seed particles can act as surfaces upon which the dissolved species can precipitate and grow heterogeneously. This can be in contrast to homogeneous nucleation and growth of the dissolved materials wherein the dissolved species is forced to spontaneously precipitate out of solution forming a range of particle sizes including very small particles. In the case of heterogenous precipitation, the energy requirement for achieving controlled precipitation via seeding can be much lower than in the case of homogenous precipitation. Furthermore, the uniformity of particle size and morphology can be more easily controlled by careful selection of seed material properties, including seed particle size, porosity, and morphology.

The feedstock siliceous materials contemplated for use in this process may contain other components in addition to silica. Alumina and aluminum hydroxide are ubiquitous materials which may also be found in siliceous feedstock materials, and which may be soluble under the same or similar conditions to silica. Accordingly, in some embodiments, it may be desirable to use a processing method which can accommodate the processing of materials which include both silica and alumina and/or aluminum hydroxide. In some embodiments, the feedstock siliceous material comprises alumina or aluminum hydroxide. In some cases, it may be desirable to separate the silica and alumina or aluminum hydroxide into different product streams. For example, it may be desirable to produce a processed siliceous material that contains below a certain amount of alumina or aluminum hydroxide. In some embodiments, the processed siliceous material comprises less than about 40 wt. % alumina or aluminum hydroxide. In some embodiments, the processed siliceous material comprises less than about 50 wt. %, less than about 40 wt. %, less than about 30 wt. %, less than about 20 wt. %, less than about 10 wt. %, or less than about 5 wt. % alumina or aluminum hydroxide. One way in which this could be achieved is via selective precipitation of either the silica component, or the alumina and aluminum hydroxide component. Accordingly, in some embodiments, the method comprises selectively precipitating alumina or aluminum hydroxide separately. Selective precipitation of silica or alumina and aluminum hydroxide may be accomplished by adding seed particles of the material to be selectively precipitated into the processing mixture following dissolution of the silica or alumina and aluminum hydroxide and/or through controlling reaction conditions (e.g., temperature, pressure, pH, or concentrations). In some embodiments, the method comprises selectively precipitating alumina or aluminum hydroxide by adding alumina or aluminum hydroxide seed particles to the processing mixture. In some embodiments, the alumina or aluminum hydroxide seed particles are derived from a previous processing cycle. In some embodiments, the alumina or aluminum hydroxide seed particles are derived from an extraneous source. In some embodiments, the method comprises selectively precipitating silica by adding silica seed particles to the processing mixture. In some embodiments, the silica seed particles are derived from a previous processing cycle. In some embodiments, the silica seed particles are derived from an extraneous source. In some embodiments, the temperature, pressure, pH, and/or concentrations of reactants can be controlled to specifically induce the precipitation of either alumina or silica but not both. Once one material (alumina or silica) is sufficiently precipitated, the conditions can be changed to precipitate the remaining component in a separate reactor or onto separate seed crystals.

For other products, a siliceous material that contains both silica and alumina or aluminum hydroxide may be desirable. For example, materials with alumina or aluminum hydroxide shells and silica cores may have enhanced pozzolanic reactivity, improved flowability, or both. In some embodiments, the processed siliceous material includes about 5-50 wt. % alumina or aluminum hydroxide. In some embodiments, the processed siliceous material comprises at least 5 wt. %, at least 10 wt. %, at least 15 wt. %, at least 20 wt. %, at least 25 wt. %, at least 30 wt. %, at least 35 wt. %, at least 40 wt. %, or at least 45 wt. % alumina or aluminum hydroxide. In some embodiments, the processed siliceous material comprises at most 50 wt. %, at most 45 wt. %, at most 40 wt. %, at most 35 wt. %, at most 30 wt. %, at most 25 wt. %, at most 20 wt. %, at most 15 wt. %, or at most 10 wt. % alumina or aluminum hydroxide.

In some embodiments, the method comprises precipitating alumina or aluminum hydroxide onto particles comprising a silica surface. In some embodiments, the method comprises precipitating silica onto particles comprising an alumina or aluminum hydroxide surface. In some embodiments, the processed siliceous material comprises a plurality of particles, wherein each particle comprises a silica core surrounded by an alumina or aluminum hydroxide shell. In some embodiments, the processed siliceous material comprises a plurality of particles, wherein each particle comprises an alumina or aluminum hydroxide core surrounded by a silica shell. In some embodiments, the processed siliceous material comprises a plurality of particles, wherein each particle comprises an alumina or aluminum hydroxide core and a plurality of layers, wherein the layers alternate between alumina or aluminum hydroxide and silica. In some embodiments, the processed siliceous material comprises a plurality of particles, wherein each particle comprises a silica core and a plurality of layers, wherein the layers alternate between alumina or aluminum hydroxide and silica.

In some embodiments, the method comprises removing the AF and/or AMH from the processed siliceous material. In some embodiments, the method comprises removing the AF and/or AMH from the processed siliceous material by drying the processed siliceous material. The morphology of the processed siliceous material may be important to the properties of the processed siliceous material. Accordingly, it may be important to remove the AF and/or AMH from the processed siliceous material or dry the processed siliceous material using a process which does not impact, or has a minimal impact on the morphology of the processed siliceous material. Accordingly in some embodiments, the drying of the processed siliceous material is performed using a process which preserves the morphology of the material. In some embodiments, the siliceous material is dried using flash drying, rotary drying, spray drying, heating, vacuum, or any combination thereof.

In some embodiments, the method comprises recovering at least about 90% of the fluoride-containing compound and/or the hydroxide-containing compound. In some embodiments, the method comprises recovering at least about 70%, at least about 80%, at least about 90%, at least about 95%, at least about 99%, at least about 99.5%, or at least about 99.9% of the fluoride-containing compound and/or the hydroxide-containing compound.

In some embodiments, systems disclosed herein can include multi-stage reactors for carrying the dissolution reaction, removing and capturing products of the dissolution reaction and supplying them to a later stage precipitation reactor. The systems for carrying out such processes can include a source of siliceous material and of AF and/or AMH, a reactor or reactors carrying out the dissolution and reprecipitation process, a subsystem for separating the processed solid siliceous material from the liquid, optionally rinsing and drying the solids, and optionally delivering processed solids to a manufacturing operation for cement, mortar, or concrete production. Such a system may be operated in whole or in part using renewable energy, including low embodied carbon electricity sources.

In some embodiments, a cement mortar is produced in a single mixing and reaction step, without first producing a cement powder followed by mixing with a siliceous filler, such as sand, and water. Instead, the sand can be treated according to methods described herein to create a desired amount of highly reactive silica, which may be present as a coating upon the sand particles or may be a separate distinct phase. Additional cementitious components, such as lime, clay, gypsum, and the like, can be added to the treated sand. Upon mixing and hydration, cementitious binder (such as CSH) can formed by the reaction of the added constituents with the highly reactive silica, forming a mortar comprising cementitious binder and sand. The final makeup of the mortar may comprise, at a minimum, only the binder phase and sand, or may include additional phases.

A siliceous material used as an input material according to the invention may have components that are soluble in acid alongside the silica which is soluble when reacted with AF and/or AMH. An example is calcium silicate, wherein the calcium component is soluble in acid (for example, HCl or HNO₃ or H₂SO₄) while the silica is soluble with AF and/or AMH. Accordingly, an acidic solution also containing AF and/or AMH may be used to simultaneously or sequentially leach or react said calcium silicate. The ratio of AF and/or AMH to acid may vary widely. For example, in the instance where NH₄F is used in combination with H₂SO₄, the molar ratio NH₄F:H₂SO₄ may be greater than one or less than one, may be about 3:1, or may have a large excess of sulfuric acid such that the ratio is as low as 0.001:1. Generally, the leaching or dissolution of one phase can accelerate the leaching or dissolution of the other phase. Optionally, when phases are present that are each preferentially leached by one of the reactants, a sequential process may be used. For example, the calcium silicate may be first reacted with acid to dissolve or partially dissolve the calcium constituent, and subsequently with AF and/or AMH to dissolve or partially dissolve the silica component, or the order of operations may be reversed.

According to some embodiments, any of the chemical dissolution reactions described herein may be supplemented with mechanical energy, for example through grinding or milling. As an example, a siliceous material undergoing leaching with AF and/or AMH solution or with acid may be simultaneously ground using, for example, ball milling or attritor milling, to increase the efficiency or rate of the chemical reaction(s).

In another aspect, provided herein are processed siliceous materials. In some embodiments, the processed siliceous material can be prepared according to any of the methods described herein. In some embodiments, the processed siliceous material has a strength activity index (for example, as described in ASTM C618 involving the casting and destructive testing of mortar cubes comprising 20% of the SCM) of at least about 75, and a water requirement (for example as described in ASTM C618 involving the flow table assessment of a mortar blend comprising 20% of the SCM) of at most about 115% of an OPC control when blended in to OPC at 20% mass. In some embodiments, the strength activity index may be measured in accordance with the methods described in ASTM C311, (“Standard Test Methods for Sampling and Testing Fly Ash or Natural Pozzolans for Use in Portland-Cement Concrete”). In some embodiments, the processed siliceous material has a strength activity index of at least about 50, at least about 55, at least about 60, at least about 65, at least about 70, at least about 75, at least about 80, at least about 85, at least about 90, at least about 95, at least about 100, at least about 105, at least about 110, or at least about 115. In some embodiments, the processed siliceous material has a strength activity index of at most about 150, at most about 145, at most about 140, at most about 135, at most about 130, at most about 125, at most about 120, at most about 115, at most about 110, at most about 105, at most about 100, at most about 95, at most about 90, at most about 85, or at most about 80. In some embodiments, the processed siliceous material has a strength activity index of about 50-150, about 65-135, about 65-125, about 70-120, or about 75-115. In some embodiments, the processed siliceous material has a water requirement of at least about 50, at least about 55, at least about 60, at least about 65, at least about 70, at least about 75, at least about 80, at least about 85, at least about 90, at least about 95, at least about 100, at least about 105, at least about 110, or at least about 115. In some embodiments, the processed siliceous material has a water requirement of at most about 150, at most about 145, at most about 140, at most about 135, at most about 130, at most about 125, at most about 120, at most about 115, at most about 110, at most about 105, at most about 100, at most about 95, at most about 90, at most about 85, or at most about 80. In some embodiments, the processed siliceous material has a water requirement of about 50-150, about 65-135, about 65-125, about 70-120, or about 75-115.

In some embodiments, the processed siliceous material has a mass weighted median particle diameter of between about 1 and about 10 micrometers. In some embodiments, the processed siliceous material has a mass weighted median particle diameter of between about 1 and about 10 micrometers, between about 1 and about 9 micrometers, between about 1 and about 8 micrometers, between about 1 and about 7 micrometers, between about 1 and about 6 micrometers, between about 1 and about 5 micrometers, between about 1 and about 4 micrometers, between about 1 and about 3 micrometers, between about 1 and about 2 micrometers, between about 2 and about 10 micrometers, between about 2 and about 9 micrometers, between about 2 and about 8 micrometers, between about 2 and about 7 micrometers, between about 2 and about 6 micrometers, between about 2 and about 5 micrometers, between about 2 and about 4 micrometers, between about 2 and about 3 micrometers, between about 3 and about 10 micrometers, between about 3 and about 9 micrometers, between about 3 and about 8 micrometers, between about 3 and about 7 micrometers, between about 3 and about 6 micrometers, between about 3 and about 5 micrometers, between about 3 and about 4 micrometers, micrometers, between about 4 and about 10 micrometers, between about 4 and about 9 micrometers, between about 4 and about 8 micrometers, between about 4 and about 7 micrometers, between about 4 and about 6 micrometers, between about 4 and about 5 micrometers, between about 5 and about 10 micrometers, between about 5 and about 9 micrometers, between about 5 and about 8 micrometers, between about 5 and about 7 micrometers, between about 5 and about 6 micrometers, between about 6 and about 10 micrometers, between about 6 and about 9 micrometers, between about 6 and about 8 micrometers, between about 6 and about 7 micrometers, between about 7 and about 10 micrometers, between about 7 and about 9 micrometers, between about 7 and about 8 micrometers, between about 8 and about 10 micrometers, between about 8 and about 9 micrometers, or between about 9 and about 10 micrometers. The mass weighted median particle diameter of a composition may be measured according to methods described in ASTM C1070.

In some embodiments, the processed siliceous material comprises a bulk density of at least about 0.5 g/cm², at least about 1 g/cm², at least about 1.5 g/cm², at least about 2 g/cm², or at least about 2.5 g/cm². In some embodiments, the processed siliceous material comprises a bulk density of about 0.5 g/cm², about 1 g/cm², about 1.5 g/cm², about 2 g/cm², or about 2.5 g/cm².

In some embodiments, the processed siliceous material comprises a bulk density of between about 0.5 g/cm² and about 2.5 g/cm², between about 1 g/cm² and about 2.5 g/cm², between about 1.5 g/cm² and about 2.5 g/cm², between about 2 g/cm² and about 2.5 g/cm², between about 0.5 g/cm² and about 2 g/cm², between about 1 g/cm² and about 2 g/cm², between about 1.5 g/cm² and about 2 g/cm², between about 0.5 g/cm² and about 1.5 g/cm², between about 1 g/cm² and about 1.5 g/cm², or between about 0.5 g/cm² and about 1 g/cm². Bulk density may be measured, for example, according to the methods described in ASTM C311.

In some embodiments, the processed siliceous material has a specific surface area of between about 1 m²/g and about 100 m²/g. In some embodiments, the processed siliceous material has a specific surface area of about 1 m²/g, about 10 m²/g, about 20 m²/g, about 30 m²/g, about 40 m²/g, about 50 m²/g, about 60 m²/g, about 70 m²/g, about 80 m²/g, about 90 m²/g, or about 100 m²/g. In some embodiments, the processed siliceous material has a specific surface area of between about 1 m²/g and about 100 m²/g, between about 20 m²/g and about 100 m²/g, between about 40 m²/g and about 100 m²/g, between about 80 m²/g and about 100 m²/g, between about 1 m²/g and about 80 m²/g, between about 20 m²/g and about 80 m²/g, between about 40 m²/g and about 80 m²/g, between about 60 m²/g and about 80 m²/g, between about 1 m²/g and about 60 m²/g, between about 20 m²/g and about 60 m²/g, between about 40 m²/g and about 60 m²/g, 1 m²/g and about 40 m²/g, 20 m²/g and about 40 m²/g, or 1 m²/g and about 20 m²/g. The specific surface area of a composition may be measured, for example, according to the methods described in ASTM C1240. For example, specific surface area may be measured according to the methods described in ASTM C1069 (which is referenced by ASTM C1240), which describes the calculation of nitrogen absorption surface area using the Brunauer-Emmett-Teller (BET) equation.

In some embodiments, the processed siliceous material comprises less than about 2 wt. % fluorine. In some embodiments, the processed siliceous material comprises less than about 10 wt. % fluorine, less than about 5 wt. % fluorine, less than about 4 wt. % fluorine, less than about 3 wt. % fluorine, less than about 2 wt. % fluorine, less than about 1 wt. % fluorine, less than about 0.5 wt. % fluorine, less than about 0.4 wt. % fluorine, less than about 0.3 wt. % fluorine, less than about 0.2 wt. % fluorine, or less than about 0.1 wt. % fluorine.

In some embodiments, the processed siliceous material comprises less than 40 wt. % alumina or aluminum hydroxide. In some embodiments, the processed siliceous material comprises less than about 50 wt. %, less than about 40 wt. %, less than about 30 wt. %, less than about 20 wt. %, less than about 10 wt. %, or less than about 5 wt. % alumina or aluminum hydroxide. In some embodiments, the processed siliceous material comprises at least 5 wt. % alumina or aluminum hydroxide. In some embodiments, the processed siliceous material comprises a plurality of particles, wherein each particle comprises a silica core surrounded by an alumina or aluminum hydroxide shell.

In some embodiments, a plurality of feedstock siliceous materials can be used to generate a processed siliceous material. In some embodiments, the plurality of feedstock siliceous materials can be more than one of any of the feedstock siliceous materials disclosed herein. In some embodiments, the feedstock sources are used in combination to generate a siliceous material product with desired flowability and reactivity properties. Through combination of feedstocks with different chemical, crystallographic, and morphological differences, the product material properties may be tuned to have different chemical, crystallographic, and morphological properties. In some embodiments, the feedstocks may be added simultaneously and in other embodiments, they may be added sequentially. For example, it may be desirable to mix a high surface area silica feedstock siliceous material (e.g., an acid leached tailing of a mafic or ultramafic rock) and a low surface area feedstock siliceous material (e.g., a high silica content mineral) as the plurality of feedstock siliceous materials to generate a processed siliceous material.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular. Further, any step of any embodiment described herein can be used in any other embodiment.

The preceding description of the disclosed embodiments is provided to enable any person skilled in the art to make or use the described embodiment. Various modifications to these embodiments will be readily apparent to those skilled in the art, and the generic principles defined herein may be applied to other embodiments without departing from the scope of the disclosure. Thus, the present invention is not intended to be limited to the embodiments shown herein but is to be accorded the widest scope consistent with the following claims and the principles and novel features disclosed herein.

### ENUMERATED EMBODIMENTS

The following enumerated embodiments are representative of some aspects of the invention.
Embodiment 1A. Ammonium fluoride (NH₄F) or ammonium bifluoride (NH₄HF₂) or acid ammonium fluoride (3NH₄·HF₂), or disodium fluorophosphate (Na₂PO₃F), or mixtures, solutions, and derivatives thereof (collectively referred to as AF), and/or alkali metal hydroxides including sodium hydroxide (NaOH) or potassium hydroxide (KOH), or mixtures, solutions, and derivatives thereof (collectively referred to as AMH), used as a reagent or separating agent in the processing of a siliceous material (including silicates or silicate bearing compounds) for use in a cementitious material or application, or as a component or in a process for treating siliceous materials for use in a cementitious material or application.
Embodiment 2A. As to embodiment 1A, wherein the AF and/or AMH comprises a solid compound or mixtures of solid compounds, a melt or partially molten form of said solid compounds, and/or AF or AMH that is dissolved in a liquid, said liquid comprising water, a polar solvent, a non-polar solvent, or a mixture of said solvents.
Embodiment 3A. As to embodiments 1A or 2A, wherein the cementitious material or application is at least in part related to formation and processing of construction materials.
Embodiment 4A. Siliceous materials and methods of manufacture as described herein.
Embodiment 5A. Systems, methods, and devices as described herein.

The following further enumerated embodiments are representative of some aspects of the invention.
Embodiment 1B. A method for processing siliceous materials comprising:
   dissolving a feedstock siliceous material in the presence of a fluoride-containing compound selected from the group consisting of ammonium fluoride, ammonium bifluoride, acid ammonium fluoride, disodium fluorophosphate, or combinations thereof and/or a hydroxide-containing compound selected from the group consisting of sodium hydroxide, potassium hydroxide, or combinations thereof, and
   precipitating the dissolved feedstock siliceous material to provide a processed siliceous material.
Embodiment 2B. The method of embodiment 1B, wherein the method comprises using the processed siliceous material to prepare a cementitious material.
Embodiment 3B. The method of embodiment 2B, wherein the cementitious material is a pozzolanic cement.
Embodiment 4B. The method of any one of embodiments 1B-3B, wherein the dissolving comprises dissolving between 20 wt. % and 50 wt. % of the feedstock siliceous material.
Embodiment 5B. The method of any one of embodiments 1B-4B, wherein the dissolving comprises dissolving between 5 wt. % and 20 wt. % of the feedstock siliceous material.
Embodiment 6B. The method of any one of embodiments 1B-5B, wherein the precipitating comprises precipitating 100% of the dissolved feedstock siliceous material.
Embodiment 7B. The method of any one of embodiments 1B-6B, wherein the precipitating comprises heterogeneously precipitating the dissolved feedstock siliceous material onto an undissolved portion of the feedstock siliceous material.
Embodiment 8B. The method of any one of embodiments 1B-7B, wherein the precipitating comprises heterogeneously precipitating the dissolved feedstock siliceous material onto a siliceous material other than the feedstock siliceous material.
Embodiment 9B. The method of any one of embodiments 1B-8B, wherein the precipitating comprises homogeneously precipitating the dissolved feedstock siliceous material.
Embodiment 10B. The method of any one of embodiments 1B-9B, wherein the feedstock siliceous material is crystalline.
Embodiment 11B. The method of any one of embodiments 1B-9B, wherein the feedstock siliceous material is amorphous.
Embodiment 12B. The method of any one of embodiments 1B-11B, wherein the feedstock siliceous material comprises combustion ash.
Embodiment 13B. The method of any one of embodiments 1B-12B, wherein the feedstock siliceous material comprises a clay.
Embodiment 14B. The method of any one of embodiments 1B-13B, wherein the feedstock siliceous material comprises a natural mineral, mining tailings, acid leached materials, and/or base leached materials.
Embodiment 15B. The method of any one of embodiments 1B-14B, wherein the processed siliceous material has a strength activity index of at least 75, and a water requirement of at most 115% of an OPC control when blended into OPC at 20% mass in a cement mortar.
Embodiment 16B. The method of any one of embodiments 1B-15B, comprising preprocessing the feedstock siliceous material to remove impurities.
Embodiment 17B. The method of embodiment 16B, wherein the preprocessing comprises contacting the feedstock siliceous material with an acid.
Embodiment 18B. The method of embodiment 17B, wherein the acid is selected from the group consisting of hydrochloric acid, nitric acid, sulfuric acid, acetic acid, oxalic acid, lactic acid, and formic acid.
Embodiment 19B. The method of any one of embodiments 1B-18B, wherein the dissolving is performed in a reactor, and wherein the feedstock siliceous material entering the reactor contains less than 5 wt. % of any impurities.
Embodiment 20B. The method of any one of embodiments 15B-19B, wherein the impurities are selected from the group consisting of calcium, magnesium, iron, or combinations thereof.
Embodiment 21B. The method of any one of embodiments 1B-20B, wherein the dissolving of the feedstock siliceous material occurs in a processing mixture, and wherein the dissolving comprises decreasing the activity of ammonia in the processing mixture and/or increasing the temperature of the processing mixture.
Embodiment 22B. The method of any one of embodiments 1B-21B, wherein the precipitating of the processed siliceous material occurs in a processing mixture, and wherein the precipitating comprises increasing the activity of ammonia in the processing mixture, decreasing the temperature of the processing mixture, and/or adding acid to the processing mixture.
Embodiment 23B. The method of any one of embodiments 1B-22B, wherein the processed siliceous material comprises a plurality of particles.
Embodiment 24B. The method of embodiment 23B, comprising fractionating the particles according to particle size.
Embodiment 25B. The method of embodiment 24B, wherein the fractionating is accomplished using filtration, elutriation, gravity separation, centrifugal force, or any combination thereof.
Embodiment 26B. The method of embodiment 23B, wherein the precipitating comprises precipitating the dissolved feedstock siliceous material in the presence of a plurality of seed particles, such that the processed siliceous material has a mass weighted median particle diameter of between 1 and 10 micrometers.
Embodiment 27B. The method of any one of embodiments 1B-26B, comprising removing the fluoride-containing compound and/or hydroxide-containing compound from the processed siliceous material.
Embodiment 28B. The method of embodiment 27B, wherein the fluoride-containing compound and/or hydroxide-containing compound is removed from the processed siliceous material by washing the processed siliceous material, followed by compressed gas blowing or evacuation.
Embodiment 29B. The method of any one of embodiments 1B-28B, comprising drying the processed siliceous material.
Embodiment 30B. The method of embodiment 29B, wherein the drying of the processed siliceous material is performed using flash drying, rotary drying, spray drying, heating, vacuum, or any combination thereof.
Embodiment 31B. The method of any one of embodiments 1B-30B, wherein the feedstock siliceous material comprises alumina or aluminum hydroxide.
Embodiment 32B. The method of embodiment 31B, wherein the method comprises selectively precipitating alumina or aluminum hydroxide separately.
Embodiment 33B. The method of embodiment 31B or embodiment 32B, wherein the processed siliceous material comprises less than 40 wt. % alumina or aluminum hydroxide.
Embodiment 34B. The method of any one of embodiments 31B-33B, wherein the processed siliceous material comprises at least 5 wt. % alumina or aluminum hydroxide.
Embodiment 35B. The method of any one of embodiments 31B-34B, wherein the processed siliceous material comprises a plurality of particles, wherein each particle comprises a silica core surrounded by an alumina or aluminum hydroxide shell.
Embodiment 36B. The method of any one of embodiments 1B-35B, comprising recovering at least 90% of the fluoride-containing compound and/or hydroxide-containing compound.
Embodiment 37B. A processed siliceous material prepared according to the method of any one of embodiments 1B-36B.
Embodiment 38B. A processed siliceous material with a strength activity index of at least 75, and a water requirement of at most 115% of an OPC control when blended in to OPC at 20% mass in a cement mortar.
Embodiment 39B. The processed siliceous material of embodiment 38B, wherein the processed siliceous material comprises a plurality of particles.
Embodiment 40B. The processed siliceous material of embodiment 39B, wherein the processed siliceous material has a mass weighted median particle diameter between 1 and 10 micrometers.
Embodiment 41B. The processed siliceous material of any one of embodiments 38B-40B, wherein the processed siliceous material comprises less than 2 wt. % fluorine.
Embodiment 42B. The processed siliceous material of any one of embodiments 38B-41B, wherein the processed siliceous material comprises less than 40 wt. % alumina or aluminum hydroxide.
Embodiment 43B. The processed siliceous material of any one of embodiments 38B-41B, wherein the processed siliceous material comprises at least 5 wt. % alumina or aluminum hydroxide.
Embodiment 44B. The processed siliceous material of embodiment 43B, wherein the processed siliceous material comprises a plurality of particles, wherein each particle comprises a silica core surrounded by an alumina or aluminum hydroxide shell.
Embodiment 45B. The method of any one of embodiments 1B-36B, comprising dissolving a plurality of feedstock siliceous materials, wherein each feed stock siliceous material of the plurality of feedstock materials is different.
Embodiment 46B. A cementitious material comprising the processed siliceous material of any one of embodiments 37B-44B.
Embodiment 47B. The cementitious material of embodiment 46B, wherein the cementitious material is a pozzolanic cement.

### EXAMPLES

The presently disclosed subject matter will be better understood by reference to the following Example, which is provided as exemplary of the invention, and not by way of limitation.

### Example 1: Processing Silicates to Prepare Pozzolanic Cement

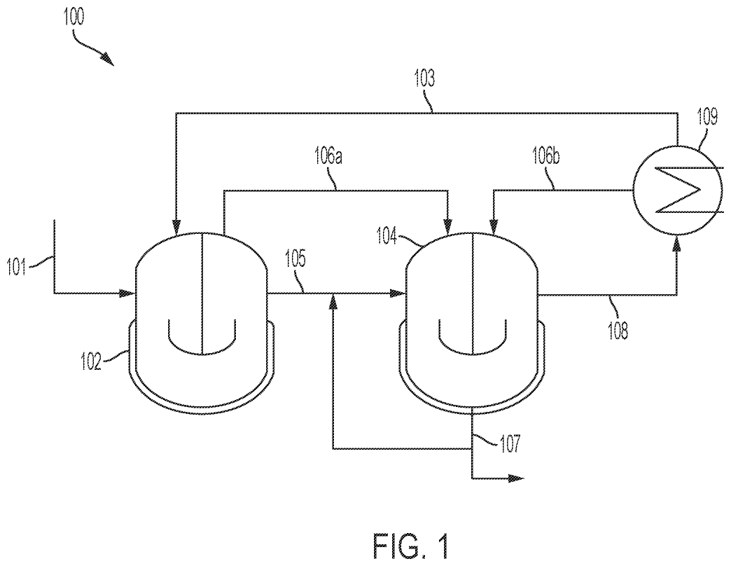

An example system 100 for producing a processed siliceous material is shown in FIG. 1. In some embodiments, a feedstock siliceous material 101 (e.g., a low value silica) from a feedstock source (not shown) can be fed to at least one reaction chamber 102 (e.g., a dissolution chamber). In some embodiments, at least one fluoride-containing compound 103 (e.g., ammonium bifluoride) and/or hydroxide-containing compound can be fed to the at least one reaction chamber 102. In some embodiments, the at least one fluoride-containing compound (and/or hydroxide-containing compound) can be from a feed source (not shown). In some embodiments, the feedstock siliceous material can be dissolved using the fluoride-containing compound in the at least one reaction chamber 102. In some embodiments, the feedstock siliceous material can be dissolved in the at least one reaction chamber 102 at a temperature of about 25-110° C. In some embodiments, the at least one reaction chamber can be configured to dissolve the feedstock siliceous material using at least one fluoride-containing compound and/or hydroxide-containing compound.

In some embodiments, the at least one reaction chamber 102 can be fluidically connected to at least one second reaction chamber 104 (e.g., a precipitation chamber). In some embodiments, the at least one first reaction chamber and the at least one second reaction chamber may be separate and not fluidically connected to one another. In some embodiments, the dissolved feedstock siliceous material 105 (e.g., in the form of H₂SiF₆) can be fed from the at least one first reaction chamber 102 to the at least one second reaction chamber 104. In some embodiments, seed particles can be introduced to the dissolved feedstock siliceous material before being fed to the at least one second reaction chamber. In some embodiments, the seed particles can be the product processed siliceous material 107. In some embodiments, gaseous or condensed ammonia 106a evolved from the at least one first reaction chamber can be fed into the at least one second reaction chamber.

In some embodiments, the at least one second reaction chamber is configured to precipitate the dissolved feedstock siliceous material to provide a processed siliceous material 107. In some embodiments, the dissolved feedstock siliceous material can precipitate using the seed particles (e.g., as heterogenous growth surfaces). In some embodiments, the precipitated dissolved feedstock siliceous material can be removed from the at least one second reaction chamber (via filtration). In some embodiments, a portion of this product outlet stream 107 can be recycled to be used as (silica) seed particles for the upstream dissolved feedstock siliceous material 105 exiting the at least one first reaction chamber. In some embodiments, the remainder of the product processed siliceous material stream can be rinsed, dried, and/or delivered to a manufacturing operation (e.g., for cement, mortar, concrete, etc.). In some embodiments, a by-product 108 of the reprecipitation reaction (e.g., NH₄F) can exit the at least one second reaction chamber and be sent to a heat exchanger 109 (e.g., a heater) to be regenerated into the at least one fluoride-containing compound 103. As such, the heat exchanger may be configured to regenerate the at least one fluoride-containing compound and/or hydroxide-containing compound. In some embodiments, the heat exchanger is fluidically connected to the at least one second reaction chamber and/or the at least one first reaction chamber. In some embodiments, regeneration of the fluoride-containing compound can produce gaseous or condensed ammonia 106b which can be sent to the at least one second reaction chamber for precipitation.

### Example 2

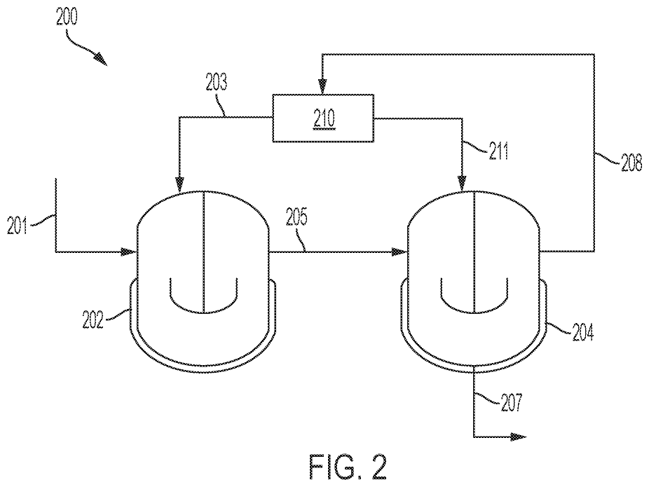

An example system 200 for producing a processed siliceous material is shown in FIG. 2. In some embodiments, a feedstock siliceous material 201 (e.g., a low value silica) from a feedstock source (not shown) can be fed to at least one reaction chamber 202 (e.g., a dissolution chamber). In some embodiments, at least one hydroxide-containing compound 203 (e.g., sodium hydroxide) and/or fluoride-containing compound can be fed to the at least one reaction chamber 202. In some embodiments, the at least one hydroxide-containing compound (and/or fluoride-containing compound) can be from a feed source (not shown). In some embodiments, the feedstock siliceous material can be dissolved using the hydroxide-containing compound in the at least one reaction chamber 202. In some embodiments, the feedstock siliceous material can be dissolved in the at least one reaction chamber 202 at a temperature of about 150-300° C. In some embodiments, the at least one reaction chamber can be configured to dissolve the feedstock siliceous material using at least one fluoride-containing compound and/or hydroxide-containing compound.

In some embodiments, the at least one reaction chamber 202 can be fluidically connected to at least one second reaction chamber 204 (e.g., a precipitation chamber). In some embodiments, the at least one first reaction chamber and the at least one second reaction chamber may be separate and not fluidically connected to one another. In some embodiments, the dissolved feedstock siliceous material 205 (e.g., in the form of Na₂SiO₃) can be fed from the at least one first reaction chamber 202 to the at least one second reaction chamber 204.

In some embodiments, the at least one second reaction chamber is configured to precipitate the dissolved feedstock siliceous material to provide a processed siliceous material 207 (e.g., SiO₂). In some embodiments, the dissolved feedstock siliceous material can precipitate using the seed particles (e.g., as heterogenous growth surfaces). In some embodiments, the precipitated dissolved feedstock siliceous material can be removed from the at least one second reaction chamber (via filtration). In some embodiments, the product processed siliceous material stream can be rinsed, dried, and/or delivered to a manufacturing operation (e.g., for cement, mortar, concrete, etc.). In some embodiments, a by-product 208 of the reprecipitation reaction (e.g., Na₂CO₃) can exit the at least one second reaction chamber and be sent to an electrolyzer 210 configured to regenerate the at least one hydroxide-containing compound 203. In some embodiments, the electrolyzer may be configured to regenerate the at least one hydroxide-containing compound and/or hydroxide-containing compound. In some embodiments, the electrolyzer is fluidically connected to the at least one second reaction chamber and/or the at least one first reaction chamber. In some embodiments, regeneration of the hydroxide-containing compound can produce gaseous carbon dioxide 211 which can be fed to the at least one second reaction chamber for precipitation (i.e., it can react with Na₂SiO₃ to precipitate SiO₂ and form Na₂CO₃ as a by-product).

### Example 3

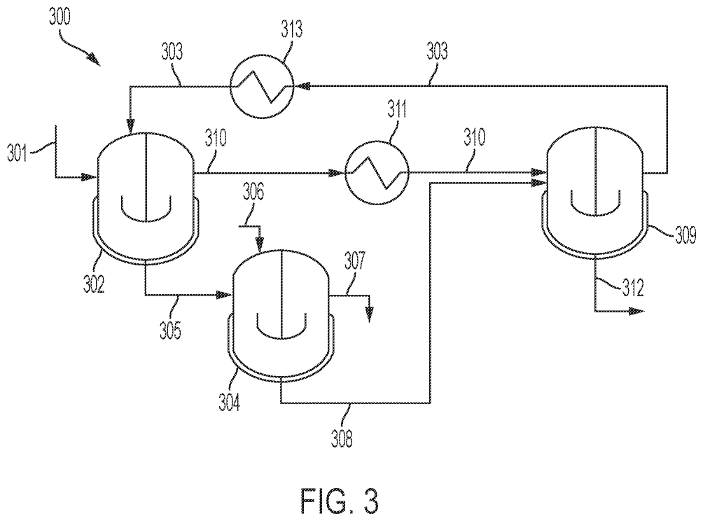

An example system 300 for producing a processed siliceous material is shown in FIG. 3. In some embodiments, a feedstock siliceous material 301 (e.g., a low value aluminosilicate) from a feedstock source (not shown) can be fed to at least one reaction chamber 302 (e.g., a dissolution chamber). In some embodiments, at least one hydroxide-containing compound 303 (e.g., sodium hydroxide) and/or fluoride-containing compound can be fed to the at least one reaction chamber 302. In some embodiments, the at least one hydroxide-containing compound (and/or fluoride-containing compound) can be from a feed source (not shown). In some embodiments, the feedstock siliceous material can be at least partially dissolved using the hydroxide-containing compound in the at least one reaction chamber 302. In some embodiments, the feedstock siliceous material can be at least partially dissolved in the at least one reaction chamber 302 at a temperature of about 150-200° C. In some embodiments, the at least one reaction chamber can be configured to partially dissolve the feedstock siliceous material using at least one fluoride-containing compound and/or hydroxide-containing compound.

In some embodiments, the portion of the feedstock siliceous material that was not dissolved 305 in the at least one first reaction chamber (e.g., base-leached siliceous material) can be filtered and washed (not shown) prior to be transferred to at least one second reaction chamber 304.

In some embodiments, the at least one first reaction chamber 302 can be fluidically connected to at least one second reaction chamber 304 (e.g., a dissolution chamber). In some embodiments, the at least one first reaction chamber and the at least one second reaction chamber may be separate and not fluidically connected to one another. In some embodiments, the portion of the feedstock siliceous material that was not dissolved 305 in the at least one first reaction chamber (e.g., base-leached siliceous material) can be fed from the at least one first reaction chamber 302 to the at least one second reaction chamber 304. In some embodiments, the at least one second reaction chamber 304 can be configured to at least partially dissolve the non-dissolved portion of the feedstock siliceous material from the at least one first reaction chamber 302. In some embodiments, the non-dissolved portion of the feedstock siliceous material from the at least one first reaction chamber 302 can be leached further in acid 306 (from a feed source not shown), thereby removing acid-soluble cations including calcium, iron, magnesium nickel, copper, additional aluminum not recovered by the first reaction chamber, or combinations thereof. In some embodiments, the dissolved portion of the non-dissolved portion of the feedstock siliceous material from the at least one first reaction chamber or (acid) leachate 307 can be sent to different downstream processing for precipitation.

In some embodiments, the twice leached (e.g., base and acid leached feedstock material) or non-dissolved portion of the feedstock material that has been partially dissolved twice 308 can be fed to at least one third reaction chamber 309. In some embodiments, the at least one second reaction chamber 304 can be fluidically connected to at least one third reaction chamber 309 (e.g., a precipitation chamber). In some embodiments, the at least one second reaction chamber and the at least one third reaction chamber may be separate and not fluidically connected to one another.

In some embodiments, the dissolved portion of the feedstock siliceous material from the at least one first reaction chamber or leachate 310 (e.g., base leachate that can include sodium aluminate) from the at least one first reaction chamber 302 can be fed to at least one third reaction chamber 309. In some embodiments, the at least one first reaction chamber 302 can be fluidically connected to at least one third reaction chamber 309 (e.g., a precipitation chamber). In some embodiments, the at least one first reaction chamber and the at least one third reaction chamber may be separate and not fluidically connected to one another. In some embodiments, the dissolved portion of the feedstock siliceous material from the at least one first reaction chamber can be sent to a heat exchanger 311 (e.g., a chiller). In some embodiments, the heat exchanger can reduce the temperature of the dissolved portion of the feedstock siliceous material from the at least one first reaction chamber. In some embodiments, the heat exchanger is fluidically connected to the at least one first reaction chamber 302 and the at least one third reaction chamber 309.

In some embodiments, the at least one third reaction chamber is configured to precipitate the dissolved portion of the feedstock siliceous material from the at least one first reaction chamber 310 onto a surface of the non-dissolved portion of the feedstock material that has been partially dissolved twice 308 to form the processed siliceous material 312. In some embodiments, the at least one third reaction chamber can be configured to form a two-layer material with an inner core comprising the non-dissolved portion of the feedstock material that has been partially dissolved twice 308 (e.g., mostly silica) and an outer layer of the dissolved portion of the feedstock siliceous material from the at least one first reaction chamber 310 (e.g., aluminum hydroxide). In some embodiments, the precipitated particles from the at least one third reaction chamber can be separated through filtration, washed, and/or dried. In some embodiments, the remaining solution 303 (i.e., at least one hydroxide-containing compound) (e.g., NaOH) from the at least one third reaction chamber can be fed to a heat exchanger 313 (e.g., heater). In some embodiments, the heat exchanger can heat the at least one hydroxide-containing compound stream. In some embodiments, the heat exchanger 313 can be fluidically connected to the at least one first reaction chamber 302 and the at least one third reaction chamber 309. As such, the at least one hydroxide-containing compound can be recycled.

1. A method for producing a cementitious material, comprising:
reacting (i) a feedstock siliceous material with (ii) a fluoride-containing compound or a hydroxide-containing compound to form an intermediate that is at least partially dissolved and to simultaneously produce a gaseous species;
increasing the activity or partial pressure of the gaseous species to reverse the dissolution reaction, thereby precipitating a processed siliceous material, and regenerating the fluoride-containing compound or the hydroxide-containing compound.

2. A method for producing a processed siliceous material, comprising:
reacting (i) a feedstock siliceous material with (ii) a fluoride-containing compound under conditions suitable to dissolve a portion of the feedstock siliceous material and leave the remaining portion of the feedstock siliceous material undissolved; and
heterogeneously precipitating the dissolved portion of the feedstock siliceous material onto the undissolved portion of the feedstock siliceous material, to produce a processed siliceous material.

3. A method for producing processed siliceous material, comprising:
reacting (i) a feedstock siliceous material with (ii) a fluoride-containing compound or a hydroxide-containing compound under suitable conditions to at least partially dissolve the feedstock siliceous material; and
precipitating the dissolved feedstock siliceous material via homogeneous and/or heterogenous precipitation to produce a processed siliceous material that has a high specific surface area of disordered silicate or aluminum silicate, and a high bulk density.

4. The method of claim 3, wherein the dissolved feedstock is heterogeneously precipitated in the presence of silica seed particles.

5. The method of claim 3, wherein the dissolved feedstock is heterogeneously precipitated in the presence of undissolved feedstock siliceous material.

6. The method of claim 3, wherein the precipitating step is controlled to first homogenously precipitate a portion of the dissolved feedstock, followed by heterogeneously precipitating remaining dissolved feedstock.

7. The method of claim 2, further comprising combining the processed siliceous material with hydrated lime and water to produce a cementitious material.

8. The method of claim 1, wherein the precipitation step occurs under suitable conditions to produce processed siliceous material having:
amorphous form;
a bulk density of between 0.5 g/cm² and 2.5 g/cm²;
a specific surface area of between 1 m²/g and 100 m²/g; or
a mass weighted median diameter of between 1 and 10 micrometers,
a strength activity index of at least 75, and
a water requirement of at most 115% of an OPC control when blended in to OPC at 20% mass in a cement mortar,
or any combination of the foregoing.

9. The method of claim 1, further comprising preprocessing the feedstock siliceous material to remove at least a portion of calcium, magnesium, iron, or combinations thereof.

10. The method of claim 1, wherein the feedstock siliceous material is reacted with a fluoride-containing compound.

11. The method of claim 10, wherein the fluoride-containing compound comprises ammonium and fluoride.

12. The method of claim 10, wherein the fluoride-containing compound is NH₄F, NH₄HF₂, or 3NH₄·HF₂, or any combination thereof.

13. The method of claim 1, wherein the feedstock siliceous material is reacted with a hydroxide-containing compound.

14. The method of claim 1, wherein the gaseous species comprises ammonia.

15. The method of claim 1, wherein the feedstock siliceous material has:
(i) at least 10% silica or silicon by mass; and
(ii) a minimized calcium, magnesium, and iron content.

16. (canceled)

17. The method of claim 1, further comprising combining the processed siliceous material with hydrated lime and water to produce a cementitious material.

18. A processed siliceous material formed from the method of claim 1, the processed siliceous material having one or more of the following properties:
amorphous form;
a bulk density of between 0.5 g/cm² and 2.5 g/cm²;
a specific surface area of between 1 m²/g and 100 m²/g;
a mass weighted median diameter of between 1 and 10 micrometers;
strength activity a strength activity index of at least 75, and
a water requirement of at most 115% of an OPC control when blended in to OPC at 20% mass in a cement mortar.
